(19) United States
(12) Patent Application Publication
(10) Pub. No.: US 2004/0211943 A1
(43) Pub. Date: Oct. 28, 2004

(54) Coating material for fuel cell separator

(76) Inventors: Masahiro Okahara, Chiba (JP); Minoru Shirahige, Chiba (JP)

Correspondence Address: Oliff & Berridge, PO Box 19928, Alexandria, VA, 22320, US

(21) Appl. No.: 10/466,241

(22) PCT Filed: Oct. 9, 2002
(86) PCT No.: PCT/JP02/10456

(30) Foreign Application Priority Data
Nov. 21, 2001 (JP) 2001-356176

(51) Int. Cl. H01B 1/24

(52) U.S. Cl. 252/511

(57) ABSTRACT

In a coating for separators for fuel cells which is coated on a surface of carbon separators or metallic separators for fuel cells wherein graphite is used as a conductive material, copolymer of vinylidene fluoride (VDF) and hexafluoropropyrene (HFP) (VDF-HFP copolymer) are contained at not less than 10% by weight as a binder of the coating, an organic solvent having compatibility with the binder is used as a medium, a content ratio of the conductive material and the binder is in a range from 15:85 to 90:10 by weight, and a content of the organic solvent is in a range from 50 to 95% by weight. Furthermore, by using an emulsion of styrene-butadiene copolymer or the like as a binder, and by containing not less than 5% by weight as a resin component, and by preparing a content ratio of the conductive material and the binder in a range from 20:80 to 95:5 by weight, and by preparing a solid content in the coating in a range from 10 to 60% by weight, a superior coating which is also a water-based coating can be obtained.

### BACKGROUND OF THE INVENTION

1. Technical Field

The present invention relates to a conductive coating forming a conductive coating film by being coated on a surface of separators, composed of carbon or metal, of a fuel cell.

2. Background Art

Since energy which is generated by a combining reaction of hydrogen and oxygen can be utilized in a fuel cell, from viewpoints of energy conservation and environmental measures, introduction and popularization of fuel cells are greatly anticipated as a next generation power generation system. In particular, polymer electrolyte fuel cells (PEFC) have a high power density and can be miniaturized. Furthermore, PEFCs can be operated at lower temperatures, and can be started and stopped easily, compared to other types of fuel cells. Therefore, for example, utilization in an electric vehicle or a small cogeneration plant for households is anticipated and has been attracting attention recently.

As a base material for separators used in such fuel cells, metallic based materials and carbon based materials are used. Metallic based materials such as stainless steels and carbon steels can be pressed to form a separator. In the case of carbon based materials, a method in which a thermosetting resin such as a phenol based resin or a furan based resin is impregnated into a base material of graphite and is hardened by thermosetting, and the material is then sintered, and a method in which carbon powder is mixed with a phenol resin, furan resin, or tar pitch, the mixture is molded into a plate by press forming or injection molding, and the plate is sintered to form vitreous carbon can be used to produce separators.

However, metal based materials exhibit superior workability and are able to form a thin separator so as to reduce the weight of the separator. Elution of metallic ions by corrosion or deterioration of electric conductivity by oxidation on the surface of metal may occur. On the other hand, although carbon based materials can supply light-weight separators, it has a problem such as gas permeability or low physical strength.

In order to solve these problems, a method in which a conductive coating film is formed on a surface of a base material of a separator can be considered. The method may prevent corrosion of metal based materials and may help overcome the problems of gas permeability and physical strength of the carbon based materials. As a method to coat film on such a base material of a separator, Japanese Unexamined Patent Application Publication No. 11-345618 discloses a technique in which conductive material composed of a powder mixture of graphite and carbon black is coated on a surface of a base material of stainless steel, which is washed with acid, in a range from 3 to 20 μm by thickness.

However, there is a problem in adhesion between a coating film which is obtained from a conductive coating and a base material of separator. For example, such a conductive coating film may be peeled from the base material of a separator under a conditions of a pressure cooker test (PCT).

Therefore, an object of the present invention is to provide a coating for a separator of a fuel cell which can form a conductive coating film exhibiting not only superior corrosion resistance but also efficient conductivity and adhesion.

### SUMMARY OF INVENTION

According to a first aspect of the invention, the invention provides a coating for separators of a fuel cell, the coating forming a conductive coating on a surface of a carbon separator or a metallic separator for the fuel cell, comprising: graphite as a conductive material, a copolymer of vinylidene fluoride (VDF) and hexafluoropropyrene (HFP) (VDF-HFP copolymer) of not less than 10 mass % as a binder of the coating, and an organic solvent having compatibility with the binder as a medium, wherein a content ratio of the conductive material and the binder is in a range from 15:85 to 90:10, and the content of the organic solvent is in a range from 50 to 95% by weight.

In the coating for separators for fuel cells of the present invention, a uniform conductive coating having a preferable thickness can be formed to improve corrosion resistance of a base material of separators by preparing the content of the organic solvent in the coating in a range from 50 to 95 mass %. Furthermore, the conductive coating obtained in this manner can exhibit superior conductivity owing to the desirable content ratio of the conductive material. Furthermore, adhesion to the base material of separator can be improved by preparing the content of VDF-HFP copolymer to be not less than 10 mass %.

In the coating for separators for fuel cells of the present invention, it is desirable that the weight ratio of VDF and HFP in VDF-HFP copolymer contained in the binder be in a range from 70:30 to 95:5.

According to the second aspect of the invention, the invention provides a coating for separators of a fuel cell, the coating forming a conductive coating on a surface of a carbon separator or a metallic separator for the fuel cell, comprising: graphite as a conductive material, one or more emulsions selected from styrene-butadiene copolymer, acryl-styrene copolymer, and acryl-silicon copolymer not less than 5 mass % as a binder of the coating, and solvent having compatibility with the binder as a medium, wherein a content ratio of the conductive material and the binder is in a range from 20:80 to 95:5 by weight, and a solid content in the coating is in a range from 10 to 60% by weight.

Also, in this coating, a uniform conductive coating having a preferable thickness is formed to improve the corrosion resistance of the base material of the separator by preparing the solid content in the coating in a range from 10 to 60 mass %. Furthermore, the conductive coating film formed in this manner exhibits superior conductivity owing to the desirable content ratio of the conductive material. Furthermore, adhesion to the base material of the separator can be improved by containing one or more of emulsions of a styrene-butadiene copolymer, an acryl-styrene copolymer, or an acryl-silicon copolymer of not less than 5 mass %.

Furthermore, as a common component of the first and second aspects, it is desirable that the conductive material comprise a carbon based mixture wherein graphite and carbon black are mixed, and that the content ratio of graphite and carbon black be 30:70 to 90:10 by weight in the present invention.

In addition, it is desirable that the average particle diameter (D50) of graphite in the conductive material be not more than 30 μm in the coating for separators of the fuel cell of the present invention.

Furthermore, in the coating for separators of the fuel cell of the present invention, it is desirable that viscosity at 25° C. be in a range from 50 to 100,000 mPa·s.

Characteristics of the coating for separators of the fuel cell of the present invention are that one or more of a copolymer of vinylidene fluoride (VDF) and a hexafluoropropylene (HFP) (VDF-HFP copolymer), or alternatively, emulsions of styrene-butadiene copolymer, acryl-styrene copolymer, or acryl-silicon copolymer be contained as a binder; an embodiment in which copolymer of vinylidene fluoride (VDF) and hexafluoropropylene (HFP) (VDF-HFP copolymer) is used as a binder is explained first.

In the coating for separators of the fuel cell of the present invention, the content ratio of the conductive material and the binder is in a range from 15:85 to 90:10, desirably 20:80 to 85:15, and more desirably 25:75 to 80:20 all by weight. As a conductive coating film which comprises the conductive coating of the present invention, it is desirable that the electrical resistance be as low as possible, and that corrosion resistance and adhesion to a base material be as high as possible. It is desirable that the content of the conductive material be increased to reduce the electrical resistance, and it is desirable that the content of the binder be increased to improve corrosion resistance and adhesion. To meet these opposing requirements, the content ratio of the conductive material and the binder is desirably in the ranges mentioned above.

Next, the increase in the content of an organic solvent in the coating for separators of the fuel cell of the present invention results in decreasing viscosity of the coating, and results in forming a thinner coating film. On the other hand, a decrease in the content of the organic solvent in the coating results in increasing the viscosity of the coating, and results in forming a thicker coating film. Although it is advantageous that the viscosity be low to some extent to form a uniform precise coating film having no pinholes, a thick coating film cannot be formed thereby. For example, in a thin coating film having a thickness of about 20 μm, although adhesion to a base material is improved, corrosion resistance is reduced. On the other hand, in the case in which the viscosity of the coating is high, although a thick coating can be formed, coating defects such as pinholes may occur, and as a result, corrosion resistance and adhesion to base material may be deteriorated.

Therefore, in the present invention, it is desirable that the content of the organic solvent be in a range from 50 to 95 mass %, and it is also desirable that the viscosity at 25° C. be in a range from 50 to 100,000 mPa·s. These viscosities are measured by a method specified in ISO 3219 (JIS Z8803). As a coating method to form a coating film, dipping, spraying, blade coating, screen printing, or the like can be used.

In the coating for separators of the fuel cell of the present invention, it is desirable that a copolymer of VDF and HFP (VDF-HFP copolymer) be contained at not less than 10 mass % as the binder of the conductive coating, and in addition, it is also desirable that the weight ratio of VDF and HFP contained in VDF-HFP copolymer be in a range from 70:30 to 95:5.

Fluoro resin can be considered to form a preferable coating film since a fluoro resin such as VDF-HFP copolymer does not absorb water in an absorption evaluated in JIS K6991, and all of the functional groups included in the resin are hydrophobic groups.

If a case in which only a resin of a VDF polymer (PVDF) is used as a binder of the coating and a case in which a VDF-HFP copolymer is contained are compared, in the case in which only a PVDF resin is used, although the resin itself exhibits superior corrosion resistance, adhesion to a base material of the separator is low, and furthermore, solubility in an organic solvent having compatibility with this binder component tends to be low. On the other hand, in the case in which a VDF-HFP copolymer is contained, the ability to coat is improved compared to the coating containing only PVDF, and corrosion resistance and adhesion to a base material are improved.

VDF-HFP copolymer resin mentioned above can be obtained by performing a reaction of VDF (vinylidene fluoride) monomer and HFP (hexafluoropropylene) monomer, and crystallinity and melting point of the resin are reduced as the copolymerization reaction progresses. Therefore, solubility in the solvent (organic solvent having compatibility) is increased, and the coating in which corrosion resistance and adhesion to a base material are improved having no pinholes can be obtained. As a result, a coating film formed by the coating of the present invention can exhibit both superior corrosion resistance and superior adhesion to a base material. In addition, in the coating for separators for a fuel cell of the present invention, other resin materials can be added to improve characteristics of the coating.

Next, the second aspect of the coating for separators for fuel cells of the present invention, in which one or more of emulsions of styrene-butadiene copolymer, acryl-styrene copolymer, or acryl-silicon copolymer is used as a binder, is explained below.

As a styrene-butadiene copolymer used in the binder, styrene-butadiene random copolymer, styrene-butadiene-styrene block copolymer, and copolymers thereof denatured by a carboxylic group can be used. Styrene-butadiene copolymer is superior from the viewpoint of adhesion to metal and flexibility of the coating. On the other hand, acryl-styrene copolymer and acryl-silicon copolymer are superior from the viewpoint of adhesion to metal and corrosion resistance. An organic solvent is not required as a solvent because these binders are emulsions, and water can be used. Therefore, it is desirable from the viewpoint of the environment, handling, and cost.

In the coating for separators of the fuel cell of the present invention, the content ratio of conductive material and binder is in a range from 20:80 to 95:5 by weight, desirably 25:75 to 90:10, and more desirably 30:70 to 85:15. As a conductive coating film formed by the conductive coating of the present invention, it is desirable that electric resistance be as low as possible, and corrosion resistance and adhesion to a base material be as high as possible as described above. It is desirable to increase the content of conductive material to reduce electrical resistance, and it is desirable to increase the content of binder to improve corrosion resistance and adhesion. To meet these opposing requirements, the ranges mentioned above are desirable as the content ratio of the conductive material and the binder.

Next, as is described above, the viscosity of the coating for separators of the fuel cell of the present invention is decreased as the solid content in the coating is decreased, and the coating film becomes thinner. On the other hand, the viscosity is increased as the solid content is increased, and the coating film becomes thicker. Furthermore, although the coating having a low viscosity to some extent is advantageous to form a precise and uniform coating film having no pinholes, a thick coating film cannot be formed thereby. However, in the case in which an emulsion based binder is used, the viscosity of the coating can be freely controlled by changing the solid content in the coating, and a uniform coating can be performed in a range from 50 to 100,000 mPa.s viscosity at 25° C. In the case in which the viscosity is too low, the coating may be repelled when it is coated on a metallic separator, or a thin coating film having low corrosion resistance may be formed. In the case in which the viscosity is high, coating defects involving of bubbles may occur, or a non-uniform coating film may be formed. Therefore, a uniform coating can be performed in a range from 50 to 100,000 mPa·s viscosity at 25° C.

It is desirable that the solid content be in a range from 10 to 60% by weight in the present invention, and it is desirable that the viscosity at 25° C. be in a range from 50 to 100,000 mPa.s similar to the first aspect of the present invention. Various methods such as dipping, spraying, blade coating, or screen printing can be performed as a coating method to form coating film.

In the coating for separators of fuel cells of the present invention, it is desirable that one or more emulsions of styrene-butadiene copolymer, acryl-styrene copolymer, or acryl-silicon copolymer be contained at not less than 5% by weight as a binder of the conductive coating.

As a result, the coating film formed by the coating of the present invention can exhibit superior corrosion resistance and adhesion to a base material. In the coating for separators of fuel cell of the present invention, other resins can be added as a binder to improve characteristics of the coating similarly.

Commonly in the first and the second aspects of the coating of the present invention, it is desirable that carbon black be added further to graphite as a conductive material. In the case in which only graphite is contained as a conductive material, although improvement of adhesion with a base material by orientation of particle arrangement is expected, the graphite exhibits resistance anisotropy and electric connections in conductive network run short. Therefore, there is a limit in reduction of electrical resistance. By adding carbon black as the carbon based mixture to fill spaces in graphite particles, electric resistance of the entirety of the coating film can be reduced. It should be noted that the content ratio of graphite and carbon black in the carbon based mixture in the conductive coating of the present invention is in a range from 30:70 to 90:10 by weight, desirably 35:65 to 85:15, and more desirably 40:60 to 80:20.

Furthermore, in the coating for separators of the fuel cell of the present invention, graphite not only works as a conductive material, but also improves the corrosion resistance. The graphite particles having a flake shape such as lepidic or scaly shape orient parallel to the surface of the coating and shelter from water or the like to improve the corrosion resistance. This sheltering effect tends to be increased as the average particle diameter of the graphite (D50) increases. However, orientation is also increased as the D50 of the graphite increases and owing to the resistance anisotropy of the graphite, electric resistance is increased as the graphite orientates. Therefore, there is an inevitable limit in size of D50 of the graphite. In the research performed by the inventers, it became clear that the average particle diameter of the graphite (D50) is desirably not more than 30 μm.

### EXAMPLE

The present invention is explained by way of examples as follows; the present invention is not limited to these examples.

### Example 1

1. Examination of Content Ratio of Conductive Material and Binder

(Preparation of a Coating and Samples)

Vinylidene fluoride-hexafluoropropyrene (VDF-10 wt % HFP) copolymer resin as a binder was dissolved in N-methylpyrrolidone (NMP) by content ratio shown in Table 1. Natural graphite powder (graphite) having an average particle diameter of 4 μm and furnace black (carbon black) were added to this solution by a ratio of 8:2, and dispersing process was performed. Finally, the solid content and viscosity were controlled by adding appropriate amount of NMP as a solvent to prepare conductive coatings for separators of fuel cell of Samples 11 to 15.

TABLE 1
Composition unit: parts by weight

| | | | Sample No. | | | | |
|---|---|---|---|---|---|---|---|
| | | | 11 | 12 | 13 | 14 | 15 |
| Conductive | Graphite | | 2.4 | 7.2 | 14.4 | 1.6 | 15.2 |
| mateiral | Carbon black | | 0.6 | 1.8 | 3.6 | 0.4 | 3.8 |
| Binder | VDF-10 wt % HFP copolymer | | 17.0 | 11.0 | 2.0 | 18.0 | 1.0 |
| Content ratio | Graphite:Carbon black | | 8:2 | | | | |
| | Conductive material:binder | | 15.85 | 45:55 | 90:10 | 10:90 | 95:5 |
| Solvent | NMP | | 80 | 80 | 80 | 80 | 80 |
| Amount of organic solvent [wt %] | | | 80 | | | | |
| Viscosity | 100/s | | 3000 | 1424 | 400 | 3500 | 350 |
| [mPa · s] | 1500/s | | 1300 | 674 | 250 | 1500 | 200 |
| Volume resistivity [Ωcm] | | | 4.0 | 0.26 | 0.005 | 7.0 | 0.003 |
| Resistivity of thickness direction [mΩcm²] | | | 14.0 | 13.0 | 0.6 | 600 | 0.4 |
| Adhesion | Before test | SS400 | ◯ | ◯ | ◯ | ◯ | ◯ |
| | | SUS304 | ◯ | ◯ | ◯ | ◯ | X |
| | After test | SS400 | ◯ | ◯ | ◯ | ◯ | ◯ |
| | | SUS304 | ◯ | ◯ | ◯ | ◯ | X |

Adhesion:
◯ No delamination,
Δ Partial delamination,
X Delamination of entire surface

Viscosities of these Samples were measured by rheometer viscometer (trade name: RV20, rheometer produced by HAKKE Co. Ltd.,). The viscosities at 100 rpm and 1,500 rpm of rotational rate of cone-shaped rotator were measured. The reason why the viscosities were measured at two kinds of rotational rates is that various kinds of methods to coat such conductive coating can be considerable. For example, coating by dipping is equivalent to the result of viscosity under low rotational rate because a weak external force is exerted on the coating, and coating by screen printing or blade coating is equivalent to the result of viscosity under high rotational rate because an external force is exerted on the coating to some extent.

Next, a conductive coating was coated on a glass plate having dimensions of 80 mm, 150 mm, and 1 mm, on a stainless steel (SUS304) plate having dimensions of 10 mm, 15 mm, and 4 mm, and on plates of stainless steel (SUS304) and carbon steel (SS400) having dimensions of 30 mm, 80 mm, and 1 mm by a doctor blade, and these were heated and dried for 15 minutes at 150 to 250° C. to prepare Samples for evaluation.

(Evaluation of the Coating Films)

The coating films of Samples for evaluation mentioned above were evaluated about volume resistivity, resistivity of thickness direction and adhesion by each method as follows. The volume resistivity was measured by performing a four probe method (Loresta AP, produced by DIA INSTRUMENTS Co., Ltd.) in which measuring terminals were applied to the coating film coated on the glass plate of a Sample to measure the volume resistivity in the horizontal direction of the coating film. The resistivity of thickness direction was measured by performing a four probe method (3560 mΩHiTESTER, produced by HIOKI E.E.) in which a Sample of the carbon steel was placed between silver plates to measure the resistivity of thickness direction in the vertical direction of the coating film with the carbon steel.

Furthermore, adhesion was measured by a method in accordance with JIS K5400 in which eleven cutting lines crossing mutually perpendicular were made to form tessellated cuts on the coating films of the stainless steel and the carbon steel of the Samples by a knife, a mending tape having width of 18 mm was applied to the coating films by finger pressure, the tape was peeled in a direction of 180 degrees, and the remaining coating film on the peeled tape was observed to evaluate the adhesion. Furthermore, after performing a pressure cooker test (at 121° C., for 24 hours under 2 atm: PCT) on each of the Samples, the adhesion of the coatings was similarly evaluated to evaluate corrosion resistance. The results are shown in Table 1.

In Samples 11 to 13 in which the content ratio of the conductive material and the binder are in a range from 15:85 to 90:10, it became clear that electrical resistance and adhesion were within an appropriate range. On the other hand, in Sample 14 in which the content ratio of the conductive material and the binder is 10:90, adhesion was sufficient, but electric conductivity was inferior, having a high resistivity of thickness direction of 600 mΩcm². Furthermore, in Sample 15 in which the content ratio of the conductive material and the binder was 95:5, efficient resistivity of thickness direction of 0.4 mΩcm² was measured, but delamination of the coating occurred after a pressure cooker test (PCT) was performed.

That is to say, in the coating for separators for the fuel cells of the present invention, adhesion tends to be improved as the content ratio of the binder is increased. However, electrical resistance is increased because the binder is insulating. On the other hand, efficient adhesion cannot be obtained if the content ratio of the binder is low. Therefore, it became clear that a suitable content ratio of the conductive material and the binder in the present invention is in a range from 15:85 to 90:10.

2. Examination of VDF-HFP Copolymer

Next, Vinylidene fluoride-hexafluoropropyrene (VDF-5, 15, 30 wt % HFP) copolymer resin and/or polyvinylidene fluoride (PVDF) resin were/was used in the content ratios shown in Table 2, conductive coatings for separators of fuel cells of Samples 21 to 26 were prepared by similar methods as the preparation of the coatings and Samples in “Examination of the content ratio of a conductive material and a binder” described above, and Samples were examined regarding effects depending on the kind of resin by similar evaluations as described above. Coating composition and results of evaluation of obtained coating films are shown in Table 2.

TABLE 2
Composition unit: parts by weight

| | | | Sample No. | | | | | |
|---|---|---|---|---|---|---|---|---|
| | | | 21 | 22 | 23 | 24 | 25 | 26 |
| Conductive | Graphite | | 8.8 | | | | | |
| material | Carbon black | | 2.2 | | | | | |
| Binder | VDF-5 wt % HFP copolymer | | 9.0 | — | — | — | — | — |
| | VDF-15 wt % HFP copolymer | | — | 9.0 | — | — | — | — |
| | VDF-30 wt % HFP copolymer | | — | — | 9.0 | 0.9 | 2.7 | — |
| | PVDF resin | | — | — | — | 8.1 | 6.3 | 9.0 |
| Content | Graphite:Carbon black | | 8:2 | | | | | |
| ratio | Conductive material:Binder | | 55:45 | | | | | |
| Content of organic solvent [wt %] | | | 80 | | | | | |
| Viscosity | 100/s | | 1040 | 940 | 891 | 1170 | 1110 | 1200 |
| [mPa · s] | 1500/s | | 580 | 525 | 498 | 653 | 618 | 670 |
| Volume resistivity [Ωcm] | | | 0.12 | 0.13 | 0.14 | 0.12 | 0.13 | 0.12 |
| Resistivity of thickness direction [mΩcm²] | | | 15.0 | 16.7 | 17.1 | 15.0 | 15.5 | 14.8 |
| Adhesion | Before test | SS400 | ◯ | ◯ | ◯ | ◯ | ◯ | ◯ |
| | | SUS304 | ◯ | ◯ | ◯ | ◯ | ◯ | X |
| | After test | SS400 | ◯ | ◯ | ◯ | ◯ | ◯ | ◯ |
| | | SUS304 | ◯ | ◯ | ◯ | ◯ | ◯ | X |

Adhesion:
◯ No delamination,
Δ Partial delamination,
X Delamination of entire surface

Efficient electrical resistance and adhesion were observed in the case in which the content ratios of HFP in VDF-HFP copolymer as a binder were prepared at 5 wt %, 15 wt %, and 30 wt % (Samples 21 to 23) and in the case PVDF resin contained VDF-30 wt % HFP copolymer in the ratios of 10% and 30% by weight respectively (Samples 24 and 25). On the other hand, delamination of the coating occurred after PCT in only the case in which PVDF resin was contained as a binder (Sample 26).

Therefore, in the coating for separators of the fuel cells of the present invention, it became clear that efficient characteristics can be obtained by preparing the weight ratio of VDF and HFP in VDF-HFP copolymer in a range from 70:30 to 95:5, and that superior characteristics can be obtained by preparing the content ratio of VDF-HFP copolymer in the coating to be not less than 10% by weight.

3. Examination of Solid Content and Viscosity

Next, conductive coatings for separators of the fuel cells of Samples 31 to 34 were prepared in the same manner as shown in preparation of the coatings and the Samples in “Examination of content ratio of a conductive material and a binder” described above, except that the contained amounts of organic solvent were changed as shown in Table 3. Effects depending on solid content and viscosity of the coatings were examined by similar evaluations as described above. Coating compositions and results of evaluation of obtained coating films are shown in Table 3.

TABLE 3
Compsition unit: parts by weight

| | | | Sample No. | | | |
|---|---|---|---|---|---|---|
| | | | 31 | 32 | 33 | 34 |
| Conductive | Graphite | | 8.8 | | | |
| material | Carbon black | | 2.2 | | | |
| Binder | VDF-15% HFP copolymer | | 9.0 | | | |
| Content | Graphite:Carbon black | | 8:2 | | | |
| ratio | Conductive material:Binder | | 55:45 | | | |
| Solvent | NMP | | 30 | 380 | 20 | 674 |
| Content of organic solvent [wt %] | | | 50 | 95 | 40 | 97 |
| Viscosity | 100/s | | 28000 | 120 | 130000 | 90 |
| [mPa · s] | 1500/s | | 5300 | 100 | 15000 | 80 |
| Volume resistivity [Ωcm] | | | 0.13 | 0.13 | 0.13 | 0.13 |
| Resistivity of thickness direction [mΩcm²] | | | 16.7 | 16.7 | 16.7 | 16.7 |
| Adhesion | Before test | SS400 | ◯ | ◯ | ◯ | ◯ |
| | | SUS304 | ◯ | ◯ | ◯ | ◯ |
| | After test | SS400 | ◯ | ◯ | ◯ | ◯ |
| | | SUS304 | ◯ | ◯ | X | ◯ |

Adhesion:
◯ No delamination,
Δ Partial delamination,
X Delamination of entire surface

Efficient adhesion was observed in the case in which the contained amount of organic solvent was 50 wt % and 95 wt % (Samples 31 and 32). However, in the case in which the contained amount of organic solvent was high (Sample 34), coating viscosity was low and a thick coating film could not be formed. In the case in which the contained amount of organic solvent was low (Sample 33), coating viscosity was high, ability to coat was deteriorated, and pinholes occurred in the obtained coating. Furthermore, delamination occurred after PCT and it was obvious that it was of no practical use.

Therefore, in the coating for separators of the fuel cells of the present invention, it became clear that the contained amount of organic solvent in the coating was in a range from 50 to 90% by weight to optimize the viscosity and coating condition of the coating.

4. Examination of Added Amount of Carbonblack

Next, conductive coatings for separators of the fuel cells of Samples 41 to 45 were prepared in the same manner as shown in preparation of the coatings and the Samples in “Examination of content ratio of a conductive material and a binder” described above, except that contained amounts of carbon black which was added to graphite in the conductive material were changed to those as shown in Table 4. Effects of added amount of carbon black were examined by similar evaluations. Coating composition and results of evaluation of obtained coating films are shown in Table 4.

TABLE 4
Composition unit: parts by weight

| | | | 41 | 42 | 43 | 44 | 45 |
|---|---|---|---|---|---|---|---|
| Conductive | Graphite | | 3.30 | 7.70 | 9.90 | 11.00 | 2.75 |
| material | Carbon black | | 7.70 | 3.30 | 1.10 | — | 8.25 |
| Binder | VDF-15 wt % HFP copolymer | | 9.0 | | | | |
| Content | Graphite:Carbon black | | 30:70 | 70:30 | 90:10 | 100:0 | 25:75 |
| ratio | Conductive material:Binder | | 55:45 | | | | |
| Solvent | NMP | | 80.0 | | | | |
| Content of organic solvent [wt %] | | | 80 | | | | |
| Viscosity | 100/s | | 1400 | 1257 | 911 | 850 | 2500 |
| [mPa · s] | 1500/s | | 751 | 597 | 532 | 520 | 1050 |
| Volume resistivity [Ωcm] | | | 0.29 | 0.08 | 0.18 | 1.47 | 1.00 |
| Resistivity of thickness direction [mΩcm²] | | | 3.68 | 1.21 | 2.43 | 30.3 | 20.2 |
| Adhesion | Before test | SS400 | ◯ | ◯ | ◯ | ◯ | ◯ |
| | | SUS304 | ◯ | ◯ | ◯ | ◯ | ◯ |
| | After test | SS400 | ◯ | ◯ | ◯ | ◯ | ◯ |
| | | SUS304 | ◯ | ◯ | ◯ | ◯ | ◯ |

Adhesion:
◯ No delamination,
Δ Partial delamination,
X Delamination of entire surface

Compared to Sample 44 in which only graphite was contained, resistance was decreased as the added amount of carbon black was increased, and also efficient adhesion was observed in Samples 41 to 43 to which carbon black was added respectively. However, high resistance was observed in Sample 45 in which the content ratio of graphite and carbon black was 25:75 by weight. Therefore, in coatings for separators of the fuel cells of the present invention, it became clear that the conductive material desirably comprises a carbon based mixture in which carbon black is added to graphite, and that the content ratio of graphite and carbon black is desirably in a range from 30:70 to 90:10 by weight.

### Example 2

1. Examination of Content Ratio of a Conductive Material and a Binder

(Preparation of Coatings and Samples)

A carbon mixture in which natural graphite powder (graphite) having an average particle diameter of 4 μm and furnace black (carbon black) were contained in a ratio of 8:2 was added to a emulsion of styrene-butadiene random copolymer (solid content 40% by weight) as a binder in ratios shown in Table 5, and spreading processes were applied to prepare coatings for separators for fuel cells of Samples 51 to 55.

TABLE 5
Composition unit: parts by weight

| | | | Sample No. | | | | |
|---|---|---|---|---|---|---|---|
| | | | 51 | 52 | 53 | 54 | 55 |
| Conductive | Graphite | | 5.6 | 16.8 | 26.6 | 2.8 | 27.4 |
| material | Carbon black | | 1.4 | 4.2 | 6.7 | 0.7 | 6.9 |
| Binder | Styrene-butadiene copolymer | | 28.0 | 14.0 | 1.7 | 31.5 | 0.7 |
| | (emulsion, solid content 40 wt %) | | | | | | |
| Content | Graphite:Carbon black | | 8:2 | | | | |
| ratio | Conductive material:Binder | | 20:80 | 60:40 | 95:5 | 10:90 | 98:2 |
| Solid content of the coating [wt %] | | | 35 | | | | |
| Viscosity | 100/s | | 434 | 305 | 200 | 500 | 180 |
| [mPa · s] | 1500/s | | 220 | 160 | 100 | 260 | 90 |
| Volume resistivity [Ωcm] | | | 4.8 | 0.34 | 0.006 | 8.4 | 0.004 |
| Resistivity of thickness direction [mΩcm²] | | | 17.0 | 15.6 | 0.7 | 720 | 0.5 |
| Adhesion | Before test | SS400 | ◯ | ◯ | ◯ | ◯ | ◯ |
| | | SUS304 | ◯ | ◯ | ◯ | ◯ | X |
| | After test | SS400 | ◯ | ◯ | ◯ | ◯ | ◯ |
| | | SUS304 | ◯ | ◯ | ◯ | ◯ | X |

| | | | | | |
|---|---|---|---|---|---|
| Ability to coat | ◯ | ◯ | ◯ | ◯ | ◯ |

Adhesion:
◯ No delamination,
Δ Partial delamination,
X Delamination of entire surface
Ability to coat:
⊚ Entire surface was uniform,
◯ Nearly the entire surface was uniform,
X Pinholes or repelling occurred

A method to evaluate the viscosity of the prepared conductive coatings is similar to Example 1.

Next, the conductive coating was coated on a glass plate having dimensions of 80 mm, 150 mm and 1 mm, on a stainless steel (SUS304) plate having dimensions of 10 mm, 15 mm and 4 mm, and to plates of a stainless steel (SUS304) and a carbon steel (SS400) having dimensions of 30 mm, 80 mm, and 1 mm by a doctor blade, and they were heated and dried for 15 minutes at 150° C. to prepare Samples for evaluation. Furthermore, as an evaluation of ability to coat, condition of coating after coating was applied on a plate of stainless steel (SUS304) by a doctor blade was observed and it was evaluated as ⊚ in the case in which a uniform coating was formed, as ◯ in the case in which nearly a uniform coating was formed, and as x in the case in which pin holes or repelling occurred.

(Evaluation of the Coating Films)

Volume resistivity, resistivity of thickness direction, and adhesion of the coating films of Samples for evaluation described above were evaluated. Evaluating methods are similar to Example 1, and these evaluating results are shown in Table 5.

It became clear that electrical resistance and adhesion of Samples 51 to 53 in which the content ratio of the conductive material and the binder is in a range from 20:80 to 95:5 were within a possible range. On the other hand, in Sample 54 in which the content ratio of the conductive material and the binder was 10:90, although adhesion is high and sufficient, electrical conductivity was deteriorated exhibiting high resistivity of thickness direction of 720 mΩcm². In Sample 55 in which the content ratio of the conductive material and the binder was 98:2, although efficient resistivity of thickness direction of 0.5 mΩcm² was observed, delamination of the coating film was observed after PCT.

That is to say, in the coating for separators for the fuel cells the present invention, although adhesion tends to be increased as the contained amount of binder is increased, electrical resistance is increased because the binder is insulating. On the other hand, when contained amount of the binder is too small, efficient adhesion cannot be obtained. Therefore, it became clear that the desirable content ratio of the conductive material and the binder in the present invention is in a range from 20:80 to 95:5 by weight.

2. Examination of Emulsion

Emulsions of styrene-butadiene random copolymer and styrene-butadiene-styrene block copolymer were used as styrene-butadiene copolymer which is a binder, acryl-styrene copolymer and acryl-silicon copolymer which comprises a copolymer of acrylate and alkoxysilane were used as acrylic emulsion, and furthermore, polyvinyl acetate emulsion as Comparative Example was used in content ratio shown in Table 6, conductive coatings for separators of the fuel cells of Samples 61 to 65 were prepared in the same manner as shown in preparation of the coatings and the Samples in “Examination of the content ratio of a conductive material and a binder” described above. Effects depending on kinds of resin were examined by the similar evaluation. Coating composition and results of evaluation of obtained coating films are shown in Table 6.

TABLE 6
Composition unit: parts by weight

| | | | Sample No. | | | | |
|---|---|---|---|---|---|---|---|
| | | | 61 | 62 | 63 | 64 | 65 |
| Conductive | Graphite | | 19.6 | | | | |
| material | Carbon black | | 4.9 | | | | |
| Binder | Styrene-butadiene random copolymer | | 10.5 | — | — | — | — |
| (emulsion, | Styrene-butadiene-styrene block copolymer | | — | 10.5 | — | — | — |
| solid content | Acryl-styrene copolymer | | — | — | 10.5 | — | — |
| 40 wt %) | Acryl-silicon copolymer | | — | — | — | 10.5 | — |
| | Poly vinyl acetate | | — | — | — | — | 10.5 |
| Content ratio | Graphite:Carbon black | | 8:2 | | | | |
| | Conductive material:Binder | | 70:30 | | | | |
| Solid content of the coating [wt %] | | | 35 | | | | |
| Viscosity | 100/s | | 500 | 450 | 600 | 800 | 1500 |
| [mPa · s] | 1500/s | | 235 | 210 | 280 | 380 | 710 |
| Volume resistivity [Ωcm] | | | 0.27 | 0.25 | 0.20 | 0.28 | 0.22 |
| Resistivity of thickness direction [mΩcm²] | | | 18.0 | 17.3 | 14.5 | 19.0 | 15.5 |
| Adhesion | Before test | SS400 | ◯ | ◯ | ◯ | ◯ | ◯ |
| | | SUS304 | ◯ | ◯ | ◯ | ◯ | X |
| | After test | SS400 | ◯ | ◯ | ◯ | ◯ | ◯ |
| | | SUS304 | ◯ | ◯ | ◯ | ◯ | X |

| | | | | | |
|---|---|---|---|---|---|
| Ability to coat | ◯ | ⊚ | ⊚˜◯ | ◯ | X |

Adhesion:
◯ No delamination,
Δ Partial delamination,
X Delamination of entire surface
Ability to coat:
⊚ Entire surface was uniform,
◯ Nearly the entire surface was uniform,
X Pinholes or repelling occurred

Sufficient electrical resistance and adhesion were observed in the case in which emulsion of styrene-butadiene random copolymer and styrene-butadiene-styrene block copolymer were used as styrene-butadiene copolymer (Samples 61 and 62). In the Sample in which styrene-butadiene-styrene block copolymer was used, repelling did not occur and the most efficient ability to coat was exhibited. Furthermore, in Samples 63 and 64 in which acryl-styrene copolymer and acryl-silicon copolymer were used, efficient electrical resistance and adhesion were observed. However, in polyacetate emulsion (Sample 65), dispersibility of the conductive material was insufficient, electrical resistance was high, and delamination of the coating film occurred after PCT.

Therefore, in the coating for separators of the fuel cells of the present invention, it became clear that superior characteristics can be obtained by adding styrene-butadiene copolymer, acryl-styrene copolymer, or acryl-silicon copolymer as emulsion based binder for not less than 5% by weight.

3. Examination of Solid Content and Viscosity

Next, conductive coatings for separators of the fuel cells of Samples 71 to 74 were prepared in the same manner as shown in preparation of the coatings and Samples in “Examination of the content ratio of a conductive material and a binder described above, except that solid content were changed as shown in Table 7. Effects depending on solid content and viscosity of the coatings were examined by the similar evaluation described above. Coating composition and results of evaluation of obtained coating films are shown in Table 7.

TABLE 7
Composition unit: parts by weight

| | | | Sample No. | | | |
|---|---|---|---|---|---|---|
| | | | 71 | 72 | 73 | 74 |
| Conductive | Graphite | | 19.6 | | | |
| material | Carbon black | | 4.9 | | | |
| Binder | Styrene-butadiene-styrene block copolymer | | 10.5 | | | |
| | (emulsion, solid content 40 wt %) | | | | | |
| Content | Graphite:Carbon black | | 8:2 | | | |
| ratio | Conductive material:Binder | | 70:30 | | | |
| Solid content [wt %] | | | 10 | 60 | 5 | 65 |
| Viscosity | 100/s | | 60 | 80000 | 35 | 180000 |
| [mPa · s] | 1500/s | | 50 | 4000 | 30 | 7000 |
| Volume resistivity [Ωcm] | | | 0.25 | 0.25 | 0.25 | 0.25 |
| Resistivity of thickness direction [mΩcm²] | | | 17.3 | 17.3 | 17.3 | 17.3 |
| Adhesion | Before test | SS400 | ◯ | ◯ | ◯ | ◯ |
| | | SUS304 | ◯ | ◯ | X | X |
| | After test | SS400 | ◯ | ◯ | ◯ | ◯ |
| | | SUS304 | ◯ | ◯ | X | X |

| | | | | |
|---|---|---|---|---|
| Ability to coat | ◯ | ◯ | ◯ | X |

Adhesion:
◯ No delamination,
Δ Partial delamination,
X Delamination of entire surface
Ability to coat:
⊚ Entire surface was uniform,
◯ Nearly the entire surface was uniform,
X Pinholes or repelling occurred

Sufficient ability to coat was observed in Samples 71 and 72 in which the solid content in the coating was in a range from 10 to 60% by weight. However, in Sample 73 in which the solid content was low, viscosity of the coating was low, repelling of the coating occurred, and a thick coating could not be formed. On the other hand, in Sample 74 in which the solid content was high, viscosity of the coating was high, ability to coat was insufficient, and pinholes occurred in the coating obtained. Furthermore, delamination of the coating occurred and the coating was of no practical use.

Therefore, in the coating for separators of the fuel cells of the present invention, it became clear that the solid content of the coating is desirably in a range from 10 to 60% by weight to optimize the viscosity and the condition of the coating.

4. Examination of Added Amount of Carbon Black

Next, conductive coatings for separators for the fuel cells of Samples 81 to 85 were prepared in the same manner as shown in preparation of the coatings and Samples in “Examination of the content ratio of a conductive material and a binder” described above, except that the amount of carbon black added to graphite in the conductive material was changed as shown in Table 8. Effects depending on added amount of carbon black were examined by the similar evaluation described above. Coating composition and results of evaluation of obtained coating films are shown in Table 8.

TABLE 8
Composition unit: parts by weight

| | | | Sample No. | | | | |
|---|---|---|---|---|---|---|---|
| | | | 81 | 82 | 83 | 84 | 85 |
| Conductive | Graphite | | 7.35 | 17.15 | 22.05 | 24.5 | 6.13 |
| material | Carbon black | | 17.15 | 7.35 | 2.45 | — | 18.37 |
| Binder | Styrene-butadiene-styrene block | | 10.5 | | | | |
| | copolymer (emulsion, solid content | | | | | | |
| | 40 wt %) | | | | | | |
| Content | Graphite:Carbon black | | 30:70 | 70:30 | 90:10 | 100:0 | 25:75 |
| ratio | Conductive material:Binder | | 70:30 | | | | |
| Solid content of the coating [wt %] | | | 35 | | | | |
| Viscosity | 100/s | | 650 | 500 | 400 | 360 | 700 |
| [mPa · s] | 1500/s | | 305 | 235 | 190 | 170 | 330 |
| Volume resistivity [Ωcm] | | | 0.35 | 0.10 | 0.22 | 1.76 | 1.20 |
| Resistivity of thickness direction [mΩcm²] | | | 4.42 | 1.45 | 2.92 | 36.36 | 24.24 |
| Adhesion | Before test | SS400 | ◯ | ◯ | ◯ | ◯ | ◯ |
| | | SUS304 | ◯ | ◯ | ◯ | ◯ | ◯ |
| | After test | SS400 | ◯ | ◯ | ◯ | ◯ | ◯ |
| | | SUS304 | ◯ | ◯ | ◯ | ◯ | ◯ |

| | | | | | |
|---|---|---|---|---|---|
| Ability to coat | ◯ | ◯ | ◯ | ◯ | ◯ |

Adhesion:
◯ No delamination,
Δ Partial delamination,
X Delamination of entire surface
Ability to coat:
⊚ Entire surface was uniform,
◯ Nearly the entire surface was uniform,
X Pinholes or repelling occurred

Compared to Sample 84 in which only graphite was contained, resistance was reduced as the added amount of carbon black was increased and sufficient adhesion was also observed in Samples 81 to 83 in which carbon black was added. However, in Sample 85 in which the content ratio of graphite and carbon black was 25:75, resistance was increased.

Therefore, in the coatings for separators for fuel cells of the present invention, it became clear that the conductive material desirably comprises a carbon based mixture in which carbon black is added to graphite, and that a desirable content ratio of graphite and carbon black is in a range from 30:70 to 90:10 by weight.

As explained up to this point, in the coatings for separators for the fuel cells of the present invention which are coated on surfaces of carbon separators or metallic separators for fuel cells wherein graphite is used as a conductive material, the conductive coating film obtained by the coating can exhibit not only superior corrosion resistance but also efficient conductivity and adhesion, by containing not less than 10% by weight of copolymer of vinylidene fluoride (VDF) and hexafluoropropyrene (HFP) (VDF-HFP copolymer) as a binder of the coating, and by using an organic solvent having compatibility with the binder as a medium, and by preparing a content ratio of the conductive material and the binder in a range from 15:85 to 90:10 by weight, and by preparing a content of the organic solvent 50 to 95% by weight.

Furthermore, by using one or more of emulsions of styrene-butadiene copolymer, acryl-styrene copolymer, or acryl-silicon copolymer as a binder for not less than 5% by weight, and by preparing a content ratio of conductive material and binder in a range from 20:80 to 95:5 by weight, and by preparing solid content in the coating in a range from 10 to 60% by weight, the coating can exhibit not only superior corrosion resistance but also efficient conductivity and adhesion, and furthermore, coatings which are sufficient also from the viewpoint of environment and cost, can be obtained.

1-6. cancelled.

7. A coating for separators of a fuel cell, the coating forming a conductive coating on a surface of a carbon separator or a metallic separator for the fuel cell, comprising: graphite as a conductive material, copolymer of vinylidene fluoride (VDF) and hexafluoropropyrene (HFP) (VDF-HFP copolymer) of not less than 10 mass % as a binder of the coating, and organic solvent as a medium having compatibility with the binder, wherein a content ratio of the conductive material and the binder is in a range from 15:85 to 90:10, and a content of the organic solvent is in a range from 50 to 95% by weight.

8. A coating for separators of a fuel cell, the coating forming a conductive coating on a surface of a carbon separator or a metallic separator for the fuel cell, comprising: graphite as a conductive material, one or more emulsions selected from styrene-butadiene copolymer, acryl-styrene copolymer, and acryl-silicon copolymer of not less than 5 mass % as a binder of the coating, and solvent as a medium having compatibility with the binder, wherein a content ratio of the conductive material and the binder is in a range from 20:80 to 95:5 by weight, and a solid content in the coating is in a range from 10 to 60% by weight.

9. The coating for separators of a fuel cell according to claim 7, wherein weight ratio of VDF and HFP in VDF-HFP copolymer which is contained in the binder according to claim 1 is in a range from 70:30 to 95:5.

10. The conductive coating for separators of a fuel cell according to claim 7, wherein the conductive material comprises a carbon based mixture in which carbon black is added to graphite in the conductive material, and the content ratio of graphite and carbon black is in a range from 30:70 to 90:10.

11. The conductive coating for separators of a fuel cell according to claim 8, wherein the conductive material comprises a carbon based mixture in which carbon black is added to graphite in the conductive material, and the content ratio of graphite and carbon black is in a range from 30:70 to 90:10.

12. The conductive coating for separators of a fuel cell according to claim 7, wherein the average particle diameter of the graphite is 30 μm or less.

13. The conductive coating for separators of a fuel cell according to claim 8, wherein the average particle diameter of the graphite is 30 μm or less.

14. The conductive coating for separators of a fuel cell according to claim 10, wherein the average particle diameter of the graphite is 30 μm or less.

15. The conductive coating for separators of a fuel cell according to claim 11, wherein the average particle diameter of the graphite is 30 μm or less.

16. The conductive coating for separators of a fuel cell according to claim 7, wherein the viscosity at 25° C. is in a range from 50 to 100,000 mPa·s.

17. The conductive coating for separators of a fuel cell according to claim 8, wherein the viscosity at 25° C. is in a range from 50 to 100,000 mPa·s.

18. The conductive coating for separators of a fuel cell according to claim 10, wherein the viscosity at 25° C. is in a range from 50 to 100,000 mPa·s.

19. The conductive coating for separators of a fuel cell according to claim 11, wherein the viscosity at 25° C. is in a range from 50 to 100,000 mPa·s.

20. The conductive coating for separators of a fuel cell according to claim 12, wherein the viscosity at 25° C. is in a range from 50 to 100,000 mPa·s.

21. The conductive coating for separators of a fuel cell according to claim 13, wherein the viscosity at 25° C. is in a range from 50 to 100,000 mPa·s.

22. The conductive coating for separators of a fuel cell according to claim 14, wherein the viscosity at 25° C. is in a range from 50 to 100,000 mPa·s.

23. The conductive coating for separators of a fuel cell according to claim 15, wherein the viscosity at 25° C. is in a range from 50 to 100,000 mPa·s.
